(19) United States
(12) Patent Application Publication
(10) Pub. No.: US 2007/0160722 A1
(43) Pub. Date: Jul. 12, 2007

(54) Reduced-fat flavored coating and methods of using same

(75) Inventors: Eric Thomas Best, Noailles (FR); David George Oakenfull, Turramurra (AU); Darryl Richard Barwick, Marysville, OH (US); Lawrence Allan Kibler, Marysville, OH (US); Christopher E. Budwig, Dublin, OH (US)

Correspondence Address: BELL, BOYD & LLOYD LLP, P.O. Box 1135, CHICAGO, IL, 60690, US

(73) Assignee: NESTEC S.A., Vevey (CH)

(21) Appl. No.: 10/596,157

(22) PCT Filed: Nov. 30, 2004
(86) PCT No.: PCT/EP04/13567

§ 371 Date: Jun. 1, 2006

(30) Foreign Application Priority Data
Dec. 2, 2003 (US) 10725216

(51) Int. Cl. A23L 1/00

(52) U.S. Cl. 426/302

(57) ABSTRACT

A reduced-fat flavored coating including a sufficient amount of flavoring agent, e.g., cocoa, to provide a selected flavor, a matrix of sugar crystals and sugar glass dispersed through the flavoring agent in an amount effective to provide the coating with sufficient structural integrity to prevent flowability at temperatures less than about 40° C., and a plurality of microspheres including a dry hydrocolloid component that are dispersed through the flavoring agent and sugar matrix to provide a slippery mouthfeel that mimics fat and begins to disperse when in contact with saliva so as to mimic the melting of cocoa butter during consumption of chocolate, wherein the flavored coating is at least substantially anhydrous and has less than about 10 weight percent fat, and wherein the fat present exists as dispersed micro-droplets. Methods of using same, e.g., to enrobe confectionery products or other food products, as well as the resultant food products, as also included.

### TECHNICAL FIELD

The present invention is directed to the manufacture of reduced-fat, flavored coatings that includes a flavoring agent, a matrix of sugar crystals and sugar glass, and a plurality of microspheres including a dry hydrocolloid component to provide a slippery mouthfeel and mimic the melting of cocoa butter during consumption of chocolate and is suitable for use with confectionery products for consumption in tropical climates.

### BACKGROUND ART

Conventionally manufactured chocolate consists of sugars, cocoa solids and protein (usually from milk) homogeneously dispersed in fats and fatty substances originating from cocoa butter. Chocolate analogues contain other vegetable fats. Often the continuous fat phase also contains dairy fat. Chocolates typically contain 30 to 38 weight percent total fat and in conventional milk chocolates the fat accounts for about 57 weight percent of the energy (calories).

Since the fatty components are the continuous phase of chocolate, the storage stability and temperature behavior primarily depend on the physical properties of the fat phase. Cocoa butter is polymorphic. Six crystal forms have been described—with different melting characteristics as noted below in Table 1 (G. Talbot, Fat eutectics and crystallization. In Physico-chemical aspects of food processing (Beckett, S. T., ed.). Blackie Academic and Professional, London, 1995, pp. 142-166.) Tempering, as part of the process of manufacturing chocolate, is aimed at ensuring that cocoa butter crystallizes mainly in the crystal forms V and VI which have the highest melting temperatures.

TABLE 1
Melting points of cocoa butter polymorphs

| Crystal | Melting point |
|---|---|
| form | (° C.) |
| I | 16-18 |
| II | 21-22 |
| III | 25.5 |
| IV | 27-29 |
| V | 34-35 |
| VI | 36 |

Nonetheless, the cocoa butter typically starts to soften at about 28° C., with consequent loss of the mechanical strength of the chocolate. This means that at the high ambient temperatures frequently encountered in tropical countries, chocolate becomes sticky or even runny. It tends to stick to the wrapper and fall apart when the wrapper is removed, leaving a semi-liquid mass that can often only be eaten with a spoon if cleanliness is desired. Enrobed chocolate products typically lose structural integrity under these conditions, with their contents often leaking and individual units tending to stick together in the packaging. Chocolate also loses the ‘snap ’that is an important (and pleasurable) textural characteristic of chocolate stored and eaten under cooler conditions. Another problem associated with the low melting point of cocoa butter is that of blooming, which is caused by the separation of the melted cocoa butter on the surface of chocolate products at higher temperatures followed by its subsequent crystallization as the temperature falls. This gives an unpleasant grayish appearance to the product, reminiscent of mold. Repeated exposure to long hot and cold cycles is particularly likely to encourage blooming.

The use of hydrocolloids to mimic fat is well known to those of ordinary skill in the art (see, for example, Deis, C. M., Reducing fat: A cutting-edge strategy, Food Product Design, Mar. 1997). Unfortunately, products made hitherto have failed to fully match the features that consumers find attractive in fatty foods, particularly confectionery products, and have met with only limited success in the market place. None of the strategies previously proposed is directly applicable or fully successful in mimicking chocolate.

Thus, it is still desired to produce flavored coatings that are low-fat, low-calorie, or both, while preferably being melt-resistant under tropical or hot conditions, and yet still retain or approach the various features of conventional flavored coatings.

### SUMMARY OF THE INVENTION

The invention encompasses a reduced-fat, flavored coating including a sufficient amount of flavoring agent, e.g., cocoa, to provide a selected flavor, e.g., chocolate flavor, a matrix of sugar crystals and sugar glass dispersed through the flavoring agent in an amount effective to provide the coating with sufficient structural integrity to prevent flowability at temperatures less than about 40° C., and a plurality of microspheres including a dry hydrocolloid component that are dispersed through the flavoring agent and sugar matrix to provide a slippery mouthfeel that mimics fat and begins to disperse when in contact with saliva so as to mimic the melting of cocoa butter during consumption of chocolate, wherein the flavored coating is at least substantially anhydrous and has less than about 10 weight percent fat, and wherein the fat present exists as dispersed micro-droplets.

In one embodiment, the hydrocolloid component includes at least one of an isolated proteinaceous material, a galactomannan, or a granular starch, or any combination thereof. In a preferred embodiment, the hydrocolloid component includes egg albumin, whey protein isolate, soy protein isolate, casein, sodium caseinate, guar gum, locust bean gum, fenugreek gum, tara gum, gum acacia, corn starch, potato starch, wheat starch, tapioca starch, or a combination thereof. In a more preferred embodiment, the hydrocolloid component includes guar gum, egg albumin, and at least one starch. In another embodiment, the hydrocolloid component includes one or more non-crosslinkable hydrocoiloids. In yet another embodiment, the hydrocolloid component will become dissolved at about 36° C. to 38° C. in saliva. In one embodiment, the microspheres swell in contact with a consumer's mouth and release a portion of the hydrocolloid component to permit disintegration thereof, i.e., without mastication. In yet another embodiment, the dispersed hydrocolloid component washes away from the mouth in about 80 to 120 percent of the time that it takes for chocolate to wash away from the mouth. The coating of the invention is also typically glossy in substantially the same manner as chocolate.

In one embodiment, the sugar matrix includes sucrose, glucose, fructose, sorbitol, mannitol, maltitol, xylitol, erythritol, lactitol, polydextrose, maltodextrin, or a combination thereof. In a preferred embodiment, the sugar matrix includes corn syrup and powdered sucrose.

In another embodiment, the reduced-fat, flavored coating further includes milk having less than about 3 weight percent water content. In one embodiment, the flavoring agent includes strawberry, cocoa, chocolate-flavored components, or a combination thereof. In yet another embodiment, the flavoring agent includes cocoa and a portion is alkalized cocoa.

The invention also encompasses coatings formed from the reduced-fat flavored coating. In one embodiment, the water activity of the reduced-fat flavored coating is about 0.45 to 0.55. In another embodiment, the flavored coating is anhydrous. In yet another embodiment, the flavored coating has a shelf-life of at least about 3 years without refrigeration. In yet another embodiment, the flavored coating will not leave a visibly detectable amount of coating on a human hand in an ambient environment. In another embodiment, the flavored coating is substantially free of a grit-increasing agent.

The invention also encompasses methods of disposing the reduced-fat flavored coating over a portion of a confectionery product and drying the coating to at least a substantially anhydrous state.

The invention further encompasses a method of making a reduced-fat flavored coating by combining a sufficient amount of flavoring agent to provide a selected flavor, a sugar matrix including a plurality of sugar crystals and sugar glass, and a plurality of microspheres including a dry hydrocolloid component to provide a slippery mouthfeel that mimics fat and begins to disperse when in contact with saliva so as to mimic the melting of cocoa butter when being consumed, combining the flavoring agent, sugar matrix, and microspheres with milk to form a flowable reduced-fat coating, and drying to at least a substantially anhydrous form to provide the coating with a non-flowable texture, wherein the reduced-fat coating has less than about 10 weight percent fat which exists as dispersed micro-droplets.

### BRIEF DESCRIPTION OF THE DRAWINGS

Further features and advantages of the invention can be ascertained from the following detailed description that is provided in connection with the drawing(s) described below:

FIG. 1 depicts different gloss levels with high gloss being provided by coatings of the invention;

FIGS. 2 and 3 depict atomic force microscopy images of dull and glossy coating surface topography to the same scale; and

FIG. 4 depicts the effects of hydrocolloids on the three stages of mouthfeel according to the invention.

### DETAILED DESCRIPTION OF THE PREFERRED EMBODIMENTS

This invention advantageously provides a formulation for a reduced-fat edible flavored coating, typically for use in connection with confectionery products, that in one embodiment closely resembles the appearance and mouthfeel of a fat-containing coating, such as a chocolate or chocolate analogue coating. The coatings of the invention have a glossy appearance and mimic the eating characteristics of conventional chocolate, e.g., organoleptic characteristics including lubricity of mouthfeel. These coatings, since they have very little fat content, typically also have much lower energy (i.e., caloric content) than conventional chocolate or other coatings, they do not suffer from fat bloom, and can at least substantially, or preferably entirely, retain their shape and texture at the elevated temperatures encountered in tropical climates, i.e., up to about 40° C. The coatings of the invention are preferably also melt-resistant in such tropical climates. Without being bound by theory, it is believed that these surprising and unexpected benefits of the present coatings are achieved in part through use of fat mimicry to provide certain benefits of fat while minimizing or avoiding certain disadvantages of fat content.

The flavored coating formulation of the invention includes a sufficient amount of a flavoring agent, such as cocoa, to provide a selected flavor, such as chocolate, as well as a matrix of sugar crystals and sugar glass dispersed through the flavoring agent in an amount effective to provide the coating with sufficient structural integrity to prevent flowability at temperatures less than about 40° C., and a plurality of microspheres including a dry hydrocolloid component that are dispersed through the flavoring agent and sugar matrix to provide a slippery mouthfeel that mimics fat and begins to disperse when in contact with saliva so as to mimic the melting of cocoa butter during consumption of chocolate. The flavored coating of the invention is preferably at least substantially anhydrous and has less than about 15 weight percent fat, and wherein the fat present exists predominantly as dispersed micro-droplets. The resultant reduced-fat flavored coating is suitable for use in conventional enrobers and other equipment, with only a modification being necessary for drying the coating as drying can take longer than with conventional coatings. This can be readily accomplished by those of ordinary skill in the art by fitting the machine with a mesh belt and stream of dehumidified air provided in the cooling tunnel. The resultant coatings can be prepared to mimic, e.g., milk or dark chocolate.

While this invention focuses specifically on flavored coatings, it teaches a novel approach to fat mimicry using a hydrocolloid component that is capable of more general application than simply flavored coatings or chocolate coatings. It can be used in any food product where fat mimicry is desired. Three distinct attributes of the fat have been identified and addressed, particularly as they relate to chocolate but also other products, as well. These include the role of the fat in providing lubricity in the mouth; mouthfeel control via the change of state from solid to liquid fat during mastication, and the role of fat in determining the light reflection characteristics of the surface of the coating—i.e., in determining gloss. The present invention surprisingly provides each of these three desirable characteristics typically found in fat-laden foods, but without the same amount of fat.

The reduced-fat edible flavored coating, typically chocolate, is prepared with a sufficient amount of a flavoring agent to provide consumers with a detectable flavor, e.g., strawberry, chocolate, or the like. If a chocolate flavor is desired, any suitable cocoa or chocolate-flavored material available may be used as the flavoring agent. When cocoa is used, it is preferably used substantially free of fat or calorie-laden materials such as cocoa butter. In one embodiment, the cocoa may even be alkalized cocoa, or include an alkalized portion. One exemplary cocoa can have about 8 to 15% fat content. The flavoring agent is typically present in an amount of about 0.001 to 30 weight percent, preferably 0.5 to 25 weight percent or 1 to 20 weight percent, of the reduced-fat flavored coating. For example, if a strawberry flavor is desired, the flavoring agent might contain about 0.1 to 15 weight percent of one or more components that provide a strawberry flavor, while about 2 to 20 weight percent of cocoa or chocolate-flavored components can be included when a chocolate flavor is selected.

The coating also includes a matrix of sugar crystals and sugar glass dispersed through the flavoring agent in an amount effective to provide the coating with sufficient structural integrity to prevent flowability of the coating at temperatures less than about 40° C. Although small amounts of liquid fat component or other components may leach out over time, these are minimal or even completely avoided over the typical shelf-life of the food products into which the reduced-fat flavored coating of the invention is included. The flavored coatings typically have a shelf-life of at least about 3 years without refrigeration, although shorter or longer times can be provided with reference to the teachings herein.

Any suitable sugar or mixture thereof can be used to form the matrix, although preferably the sugars include saccharides. The sugar crystals and glass typically include any sugars or sugar alcohols, preferably sucrose, glucose, fructose, sorbitol, mannitol, maltitol, xylitol, erythritol, lactitol, polydextrose, maltodextrin, inulin, or a combination thereof Preferably, the sugar includes corn syrup and powdered sucrose. The sugar is typically present in an amount of about 50 to 98 weight percent, preferably from about 60 to 90 weight percent. In one example, the sugar is present in an amount of about 65 to 85 weight percent. Preferably, the sugar is present in an amount of about 50 to 80 weight percent. For example, sucrose can be present in about 55 to 72 weight percent while corn syrup can be present in an amount of about 10 to 22 weight percent. Inulin can be used to replace a portion of the sugar, advantageously further reducing the glycemic index and energy content of the coatings of the invention.

Without being bound by theory, it is believe that the “sugar glass” or glassy sugar or the combination of such sugar with crystalline sugar, rather than crystalline sugar alone, provides the surprising characteristics of the coatings of the present invention. Sugar glass fractures easily upon consumption and dissolves even faster than an equivalent crystalline sugar structure. Thus, the ratio of sugar glass to crystalline sugar permits increased control of the dissolution characteristics while being consumed, i.e., “in-mouth.” This dissolving effect is different from the disintegrating effect caused by gum swelling that breaks the coating mass into tiny fragments during consumption. The glassy sugar forms upon drying the mass of the invention to a point where the viscosity is sufficiently high that the sugar molecules can no longer adopt a regimented, ordered layout to form crystalline sugar, even though this is ultimately a lower energy state than the glassy form. Thus, the molecules of sugar glass are random rather than ordered, and glassy rather than crystalline. Since the sugar glass molecules have less energy than ordered sugar crystal molecules, the sugar glass binding energy is lower and therefore, glassy sugar requires less energy to dissolve than sugar crystals. As a result, it is believed that more rapid dissolution of the coatings of the invention occurs using a higher ratio of sugar glass compared to sugar crystals.

The hydrocolloid component can be any suitable hydrocolloid materials available to those of ordinary skill in the art. Typically, the hydrocolloid component includes at least one of an isolated proteinaceous material, a galactomannan, or a granular starch, or any combination thereof. Preferably, the hydrocolloid component includes egg albumin, whey protein isolate, soy protein isolate, casein, sodium caseinate, guar gum, locust bean gum, fenugreek gum, tara gum, gum acacia, corn starch, potato starch, wheat starch, tapioca starch, or a combination thereof. More preferably, the flavored coating includes a hydrocolloid component that includes guar gum, egg albumin, and at least one starch. The hydrocolloid component is typically present in an amount sufficient to increase the coating viscosity during drying so that a suitable amount of sugar glass forms. During drying, the hydrocolloid component inhibits sugar crystallization, which facilitates the remainder of dissolved sugar forming into sugar glass rather than crystals. Thus, the hydrocolloid component preferably is present in an amount of about 0.1 to 8 weight percent, preferably from about 2 to 5 weight percent, of the reduced-fat flavored coating. In one preferred example, about 3 to 4 weight percent of the hydrocolloid component is present.

It is desired that the hydrocolloid component includes one or more non-crosslinkable hydrocolloids. The hydrocolloids are preferably non-crosslinkable so that they more readily dissolve typical mouth temperatures of about 36° C. to 38° C. The hydrocolloids can provide the coating with one or more surprising characteristics typically found in fat-bearing foodstuffs, such as cream texture, silky feeling to a consumer's hands even at tropical temperatures, or the like.

The hydrocolloid component is preferably disposed as a plurality of microspheres. smooth microspheres formed from hydrocolloids. By acting as “ball bearings”, these microspheres can also provide the final coating a mouthfeel similar to fat in chocolate and chocolate analogue or chocolate-style products. The microspheres of hydrocolloid component typically swell in contact with a consumer's mouth, or in contact with saliva, and release a portion of the hydrocolloid component to permit disintegration thereof without mastication. This is also called the “melt away” ability. Preferably, at least a majority of the hydrocolloid component is collectively released from the microspheres, more preferably at least about 80 weight percent of the hydrocolloid component is released. In a preferred embodiment, at least about 90 weight percent, more preferably at least about 98 weight percent, of the hydrocolloid component is released from the microspheres during consumption to provide the surprising and beneficial fat mimicry of the present invention. In embodiments where lower percentages of microspheres disintegrate to provide the hydrocolloid component, a larger relative amount of microspheres or hydrocolloid component can be included.

The hydrocolloid component disperses from the plurality of microspheres. The dispersed hydrocolloid component typically washes away from the mouth in about 80 to 120 percent of the time that it takes for chocolate to wash away from the mouth, thereby providing a mouthfeel similar to that of fat in conventional chocolate. Without being bound by theory, this characteristic is provided by saliva or water entering the coating so as to swell the hydrocolloid component therein and cause it to disintegrate in the mouth. The larger surface area and higher sugar content compared to conventional chocolates causes dissolving of the hydrocolloid component at a rate substantially similar to that of the kinetics of cocoa butter melting.

Optionally, the reduced-fat coatings of the invention can include one or more other components, including a coloring agent, an opacifying agent, a processing aid, mold inhibitor, or the like, or a mixture thereof. A suitable coloring agent can be included in amounts sufficient to help provide the appearance of dark chocolate or milk chocolate. One component that can be included is titanium dioxide, which when used can be included in an amount of about 0.01 to 3 weight percent, preferably 0.5 to 1.5 weight percent. Exemplary amounts include 0.6, 0.8, 1, 1.2, 1.4 and 1.5 weight percent of titanium dioxide.

The coatings of the invention are substantially free, or completely free except possibly for trace amounts, of several ingredients that tend to weaken or prevent proper formation of the sugar crystal matrix. The coatings are at least substantially anhydrous, preferably anhydrous. The substantially anhydrous form of the finished coatings, i.e., dried coatings, can be formed from masses containing aqueous or water-based materials, such as a liquid milk component. Liquid milk components can be non-fat or whole milk, and optionally in partially dehydrated form. The liquid, e.g., milk, in aqueous form is typically incorporated in the mass in an amount such that it provides no more than about 15 weight percent water content. Milk may also be added in lower amounts or in powder form, such as milk solids. Sufficient water is then removed from the milk component, typically through a drying or evaporative process, so that the coating is substantially anhydrous.

The drying process typically needs to be modified for each type or size of the conventional or novel center on which the coating is disposed, and such routine modifications will be readily known or can be readily determined by those of ordinary skill in the art. For example, a small portion of moisture could be added to a particularly dry center to facilitate proper drying of the coating thereon. The coatings should be dried so that a majority of dispersed solids are trapped within a suitable volume of glassy state matrix, and if this is not done properly a sugar bloom may result over time--either at the coating surface or just beneath it so as to not be readily visible. For example, the complete drying process typically occurs within about 90 minutes, preferably within about 60 minutes. Temperatures are preferably close to ambient, such as about 21° C. to 24° C., with humidity varying from about 5 to 55%. Preferably, drying is accomplished more rapidly in air of lower humidity such as below about 15%, as this minimizes the effects various coated materials will provide to the gloss of the coating disposed thereon. It is also possible to dry coatings of the invention over longer periods of time with air of higher humidity; these variables are also dependent on the ambient relative humidity and coated material composition, as well.

The flavored coatings can be applied to any suitable type of food that might need a coating as described herein, although they are preferably applied as chocolate analogue coatings. Other common types of food for use with in the invention includes ice creams, cakes, muffins, pies, or the like. Preferably, due to the stabilization against tropical or hot temperatures up to about 40° C., the coating also will not melt in a human hand in an ambient environment. As a result, there will be an insufficient amount of coating remaining on the hand after contact to visibly detect, which inhibits formation of greasy stains on a consumer's hands. When sufficient moisture gathers on a surface contacting the coatings of the invention, however, the coating may begin to destabilize or liquefy. The coatings also preferably do not crack, such as during storage or consumption.

The reduced-fat flavored coatings of the invention are typically substantially free of a grit-increasing agent or calcium chloride. A common grit-increasing agent includes microcrystalline cellulose. The coatings of the invention are also preferably at least substantially free, more preferably entirely free, of crosslinking agents, as these tend to limit the ability of the hydrocolloid component to properly disperse when the coatings of the invention are consumed. The coatings do not require refining, conching, tempering, or the like, or any combination thereof, although one or more of these processes may be employed if desired.

The coatings of the invention can be used in conventional processing equipment, such as enrobing or panning equipment. Thus, the flavored coating can be coated over a portion of a confectionery product and still have the desired stability under hot or tropical conditions of up to about 40° C. This is achieved by drying the coating of the invention to a substantially anhydrous state. Preferably, the flavored coating has less than about 20 weight percent fat, preferably less than about 10 weight percent fat, and more preferably less than about 5 weight percent fat. In particular, less than about 3 weight percent fat is desired. An exemplary coating contains only about 1 to 2 weight percent fat content. Although fat can be added separately from the components described herein, preferably the coatings contain no added fat beyond that already present in the flavoring agent, sugar matrix, and microspheres containing the hydrocolloid component. In one preferred embodiment, flavoring agent, sugar components, microspheres, and any other components of the coating are selected to minimize or avoid fat content inherently present in such materials. The fat content that is present is preferably in a dispersed fashion within the coating, e.g., as micro-droplets. These micro-droplets preferably have a mean size of less than about 3 μm, preferably from about 1 to 3 μm. As the chocolate-style coating that exemplifies this invention is substantially fat-free, the hardness and tensile strength of the surface does not depend on the limited hardness and tensile strength of solidified fats. Thus, it is now possible to use a thinner coating than is practicable with chocolate while maintaining the same (or better) mechanical strength. For example, coating thicknesses can be less than about 95 percent, preferably less than about 90 percent, of a conventional chocolate coating thickness. Preferably, the coating thickness of the invention can be as low as about 10 to 50 percent or 20 to 40 percent, of the thickness of conventional chocolate coatings. For example, the coatings can preferably be less than about 2 mm thick, preferably less than about 1 mm thick, to facilitate dissolution of the sugar glass, disintegration of the microspheres, and even mastication of the coatings if desired. Thicknesses as low as about 0.1 mm to 0.8 mm, preferably about 0.1 mm to 0.5 mm, can be readily achieved, as well. This ability to provide thinner coatings can provide added benefit in reduction of fat and energy content of the coating, while still providing the advantages of a similar chocolate or chocolate analogue coating.

The coating of the invention supplies about 10 percent, preferably about 20 percent, and more preferably about 25 percent less energy than a typical milk chocolate based on equivalent weights of product. In one embodiment, the flavored coating of the invention can achieve a 28 percent energy reduction, i.e., fewer calories, compared to milk chocolate. For example, a coating of the invention can have less than about 450 calories/100 g milk chocolate coating, preferably less than about 400 calories/100 g milk chocolate coating of the invention. Further energy reductions are possible by partial or complete substitution of low-energy saccharides or sugar alcohols for sucrose. Conventional articles can be coated using the coating of the invention, including previously uncoated health food or low fat products that could not previously have been suitably coated with conventional chocolate or chocolate analogue coatings due to their well-known high caloric convent. Surprisingly, the resultant coatings of the invention can provide a coating where fat content provides only about 1 to 20 percent, preferably about 2 to 10 percent, of the energy therein.

Advantageously, the reduced-fat flavored coating of the invention is substantially flake-free compared to conventional chocolate. Without being bound by theory, it is believed that fracturability is not accentuated by the slip planes found in crystallized fats. This leads to decreased likelihood of flaking. Also, the coating of the invention is not softened by the elevated ambient temperatures typical of tropical climates up to about 40° C. It is softened only by interaction with the saliva in the mouth or other moisture, and preferably only by saliva. Consequently the coating of the invention retains its desirable eating characteristics under tropical conditions and causes no soiling of fingers or clothing.

Processes of making a reduced-fat flavored coating are also included. A typical process simply involves combining a sufficient amount of flavoring agent to provide a selected flavor, a sugar matrix including a plurality of sugar crystals and sugar glass, and a plurality of microspheres comprising a dry hydrocolloid component to provide a slippery mouthfeel that mimics fat and begins to disperse when in contact with saliva so as to mimic the melting of cocoa butter when being consumed, combining the flavoring agent, sugar matrix, and microspheres with milk to form a flowable reduced-fat flavored coating, and drying to at least a substantially anhydrous form to provide the coating with a non-flowable texture, wherein the reduced-fat coating has less than about 10 weight percent fat which exists as dispersed micro-droplets. The process can also include coating a plurality of candy bar centers using an enrober modified by fitting a mesh belt therewith and using a cooling tunnel supplied with dehumidified air. The flavoring agent is preferably cocoa. It is preferred to mix the flavoring agent, sugar matrix, plurality of microspheres, and any other optional components, to provide sufficient dispersion through the entire coating.

An exemplary reduced-fat chocolate analogue flavored coating of the invention can include a mixture of sugar, corn syrup, cocoa solids and chocolate flavor with the hydrocolloid component including starch, guar gum, and egg albumin. When these ingredients are mixed with a suitable amount of water or whole milk, the coating can be made to resemble molten chocolate in its appearance and flow characteristics. By including a drying step, the coating can be used to coat confectionery products that normally would be enrobed with chocolate. The resultant coated products have a dried matrix of loose, protein lubricated crystalline sugar chains formed between glassy sugar particles and individual sugar crystals. Fat is finely divided as micro-droplets in the mass.

### EXAMPLES

The following examples are not intended to limit the scope of the invention, but merely to illustrate representative possibilities concerning the present invention.

### Example 1

### Lubricity According to the Invention

Microspheres of alginate gel were prepared by spraying an aqueous solution of high guluronic acid sodium alginate (0.6% by weight) into a bath of aqueous solution of calcium chloride (5% by weight). (A SS spraying system with nozzle reference number 1/4J8C was used.) The size of the beads could be controlled by adjusting the pressure and it was found to be advantageous to add lecithin (0.2% by weight) to the calcium chloride bath to minimize surface tension effects during the formation of the gel microspheres. The size of the beads was measured using a Malvern particle size analyzer. It was found optimal to prepare a blend of 1 micron and 5 micron microspheres in approximately equal proportions.

Chocolate chips were prepared using a reduced quantity of cocoa butter and the alginate microspheres as a fat mimetic. These chocolate chips were baked into cookies. The optimum appearance and sensorial appeal was obtained by reducing the fat in the chocolate chip to only 5% and adding 19% microspheres. The control chocolate chips had 24% cocoa butter. In particular, the hydrocolloid component and microspheres of the invention impart an oily characteristic, slimy characteristic, or both.

The organoleptic characteristics and mouthfeel of the modified cookies was substantially the same as regular cookies, confirming that hydrocolloid microbeads of the invention are capable of giving fatty mouthfeel in chocolate-style coating products.

### Example 2

### Gloss According to the Invention

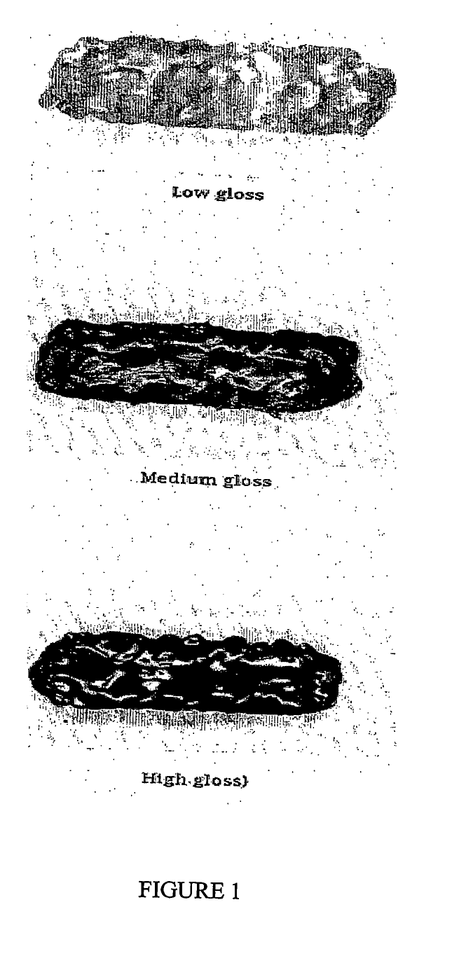

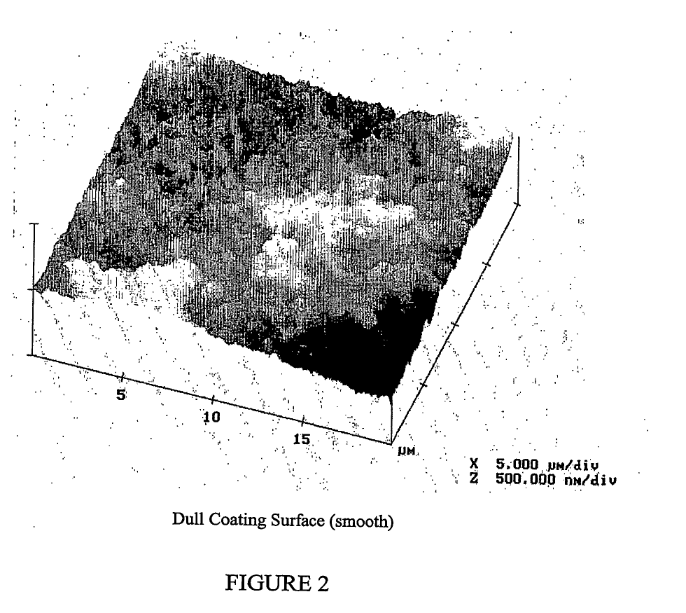

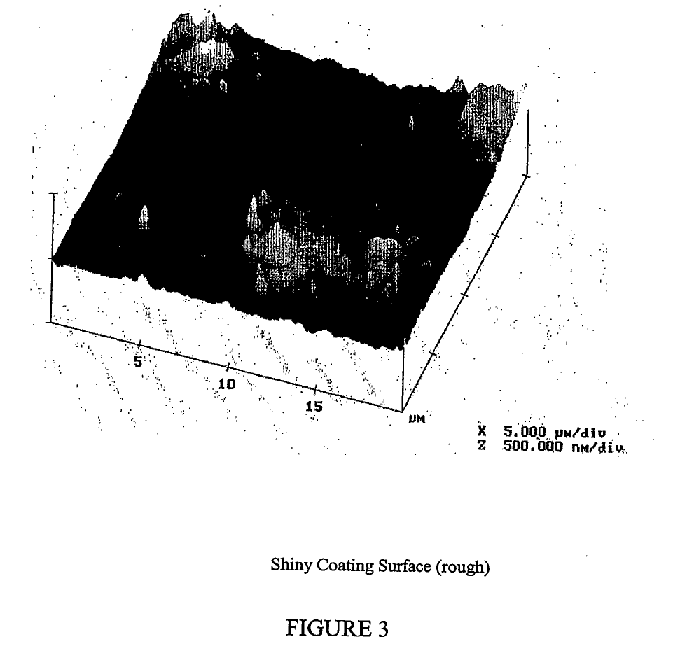

A glossy appearance is an important and desired characteristic of conventional chocolate, so much so that a dull appearance is often viewed as a quality negative. Glossy appearance is another aspect of chocolate conferred by its fat content. “Gloss” is a function of surface topography. The surface topography of a variety of materials with dull or shiny surfaces was studied using a Dimension 3000 Scanning Probe Microscope (SPM) in tapping mode. The SPM images revealed that a high gloss surface typically has a high roughness index but at the same time has many parabolic depressions or concavities that act as reflectors of incident light, as shown in FIG. 1. (This effect is termed the “sequin phenomenon”.) In contrast, for dull surfaces, SPM images typically revealed a low roughness index but many convex protrusions that randomly scatter incident light (FIGS. 2 and 3).

An explanation for this observation comes from the paint industry. Gloss paints can have the same particle size distribution as matte finish paints. However, a key difference is the surface tension. Polymers are used in gloss paints to maximize the surface tension and solvents are specifically chosen to control the setting rate. For those of ordinary skill in the art, it is quite practical to control the effect to generate almost any desired degree of shininess or dullness based on the teachings herein.

### Example 3

### Mouthfeel Control According to the Invention

The appealing texture of conventional chocolate depends on the fact that the fat melts in the mouth. All six polymorphs of cocoa butter (Table 1) melt below body temperature (37° C.). This change of state from solid to liquid is highly desirable during mastication. It aids in generating a controlled flavor release. It also aids in the generation of mouthfeel and in liquefying the mass for easy swallowing.

Three stages of mouthfeel were identified and measured by a sensory panel:

1) The loss of the feeling of solids.

2) The onset of the feeling of velvetiness.

3) The disappearance of the sensation of the coating on the tongue.

Samples were evaluated for each of these three stages using a standardized mastication procedure of one closure of the teeth per second and using a cube-shaped portion of 5 grams weight. Standard errors were determined based on 30 timings per subject using standard material:

| | Standard error |
|---|---|
| Function | (seconds) |
| Solidity loss | 0.9 |
| Velvety start | 2.1 |
| Coating disappearance | 2.3 |

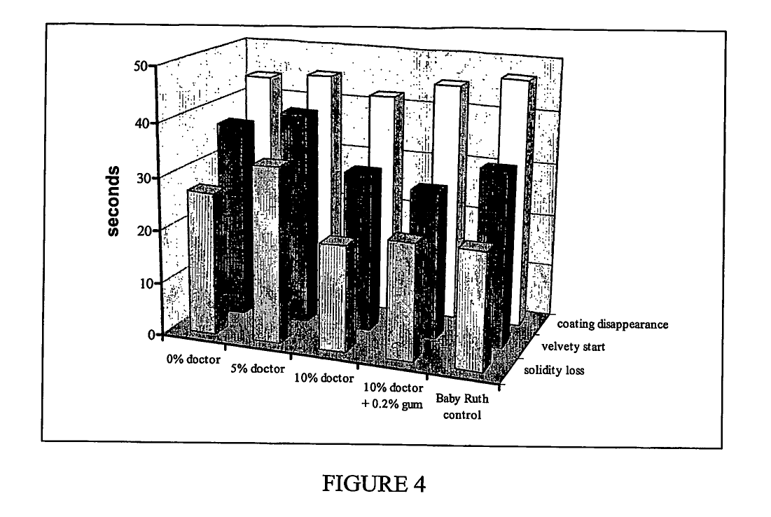

Based upon such timings a range of modifications were made to the chocolate-style coating, as shown in FIG. 4, to illustrate the effects of hydrocolloids on the three stages of mouthfeel.

Thus mouthfeel during the simulated “melting” of the chocolate-style coating could be controlled by adjusting the way in which the ingredients changed shape during swelling and solution. Melt-away was influenced by solution characteristics of hydrocolloids rather than the actual melting of fat. Special hydrocolloids (including globular swellers, hot, split soaked and wet milled types of gums, etc.) were evaluated to satisfy the various textural requirements. Optimization resulted in a selection from the guar, albumin, starch and glucose polymer families, although others may be perfectly suitable for use in the present invention. For example, hydrocolloid particles that swell very fast on contact with saliva were used to help break up the coating. The unctuous mouthfeel of fat was mimicked by creating a combination of pastiness and sliminess. Globular swollen hydrocolloid structures were used to create ball bearing effects.

### Examples 4 and 5

### Dark and Milk Chocolate Analogue Coatings of the Invention

A set of formulations was derived that were found to give coatings closely resembling the flavor and texture of chocolate, including the crumbliness thereof. Versions for “dark chocolate” and “light chocolate” types of coatings are given in Table 2.

TABLE 2
Formulations for “dark chocolate” and “milk chocolate” versions
of the chocolate-style coating.

| | Parts | |
|---|---|---|
| Ingredient | “Dark chocolate” | “Milk chocolate” |
| Sucrose | 660 | 700 |
| Corn syrup | 180 | 180 |
| Liquid whole milk | 150 | 150 + 8 parts TiO₂ |
| Cocoa | 100 | 50 |
| Starch | 20 | 20 |
| Flavor | 8.3 | 1.6 |
| Albumin | 8.3 | 8.3 |
| Guar | 5 | 5 |
| Loss of water on drying | (130) | (130) |

### Example 6

### Microbial Stability

Microbiological analysis of a few dried coatings of the invention gave the following results after 48 hours:

| Analysis | Result | Units |
|---|---|---|
| Coliform petrifilm | <10 | /g |
| E. coli petrifilm | <10 | /g |
| Mold | <10 | /g |
| Yeast | <10 | /g |
| Salmonella | Negative | /50 g |
| Listeria | Negative | /25 g |
| Aerobic plate count | <10 | /g |

These results show no evidence of microbiological growth. Moreover, the water activity (a_{w}) of the dry coating (applied to different centers) was typically from about 0.45 to 0.55 (depending on drying conditions)—well below the minimum a_{w} for pathogen growth.

### Example 7

Nutritional Advantages of The Coating—Low Energy, Low Fat

An estimate of the energy (Calories) supplied by the chocolate analogue coating of the invention, whether dark or light, is compared with dark chocolate and milk chocolates in Table 3. The chocolate coating of the invention supplies approximately 28 percent less energy than milk chocolate. Also, significantly from a nutritional point of view, only about 4 percent of the energy from the coating is from fat, compared with roughly 57 percent from fat with conventional milk chocolate.

Further reduction in energy is possible by partial or complete substitution of low-energy saccharides or sugar alcohols for the sucrose used in the formulations in Table 2. Some examples are shown in Table 4.

TABLE 3
Energy comparison of the chocolate-style
coating with conventional chocolates.

| | Energy/100 g | | |
|---|---|---|---|
| | Cal. | kJ | Energy from fat (%) |
| Chocolate Coating of Inv. | 380* | 1,600* | 4 |
| Dark chocolate | 500¶ | 2,100¶ | 50 |
| Milk chocolate | 525¶ | 2,200¶ | 57 |

*Based on fat 9 Cal./g; carbohydrate 4 Cal./g; protein 4 Cal./g; dietary fiber 2 Cal./g.
¶Calculated from data supplied by the International Cocoa Organization on www.icco.org

TABLE 4
Energy comparison for chocolate-style coatings prepared
with 100% substitution of sugar alcohols for sucrose.

| | Cal./100 g | kJ/100 g |
|---|---|---|
| Sucrose | 380 | 1,600 |
| Sorbitol | 290* | 1,200* |
| Maltitol | 250¶ | 1,100¶ |

*Based on 2.6 Cal./g for sorbitol
¶Based on 2.1 Cal./g for maltitol

### EXAMPLE 8

### Low-Fat Milk Chocolate Coating of the Invention

The ingredients (in grams) are as follows:

| | |
|---|---|
| Sucrose | 700 |
| Corn syrup (42 DE, 80% TSS) | 180 |
| Whole liquid milk | 150 (approx.) |
| Cocoa | 50 |
| Corn starch | 20 |
| Flavor | 17 |
| Albumin | 8.3 |
| Guar gum | 5 |

1. The dry ingredients are thoroughly mixed. The corn syrup, flavor and approximately one quarter of the milk are place in a planetary mixer and blended. The dry ingredients are added step-wise, gradually blending in more milk until the right viscosity is obtained.
2. Mixing was accomplished by stirring at low speed for approximately 3 minutes. Care is required to ensure complete mixing (to minimize or avoid lumps and streaks). Excessive mixing speed must be avoided as air incorporation is deleterious and can cause pre-crystallization. The low-fat milk chocolate coating preparation results.

3. The low-fat milk chocolate coating preparation is enrobed or panned onto a confectionery product, then dried in a stream of air, ideally of low humidity.

### Example 9

### Low-Fat Dark Chocolate Coating of the Invention

The ingredients (in grams) are as follows:

| | |
|---|---|
| Sucrose | 650 |
| Corn syrup (42 DE, 80% TSS) | 180 |
| Whole liquid milk | 150 (approx.) |
| Cocoa | 100 |
| Corn starch | 20 |
| Flavor | 17 |
| Albumin | 8.3 |
| Guargum | 5 |

The dry and wet ingredients are mixed and used as described previously to provide a low-fat dark chocolate coating according to the invention.

### Example 10

### A Low-Fat Chocolate Coating of the Invention

The following ingredients (with the same specifications as in the previous examples) are dry mixed:

| | | |
|---|---|---|
| Sucrose | 161 | kg |
| Cocoa | 2.5 | kg |
| Starch | 500 | g |
| Albumin | 200 | g |
| Guar | 125 | g |

The following ingredients (also with the same specifications as in the previous examples) are placed in a planetary mixer:

| | | |
|---|---|---|
| Corn syrup | 4.5 | kg |
| Flavor | 200 | g |

The mix is prepared with 3.75 liters of liquid whole milk. About one quarter of the milk is mixed with the corn syrup and flavor in the planetary mixer. The dry ingredients and the remaining milk are added step-wise, ensuring complete mixing. Water was added (500 ml) to obtain a viscosity judged suitable for enrobing.

The mix was transferred to a Nielsen enrober, Babyflex model commercially available from AE Nielsen/Maskinfabrick of Farnum, Denmark, and was used to enrobe PayDay® bars. It functioned for this purpose in the same way as normal liquid chocolate.

### Example 11

### A Fat-Free Chocolate Coating of the Invention

The following ingredients were dry mixed:

| Component | Approximate weight percent |
|---|---|
| Confectioner's sugar, 10-X | 78 to 80% |
| Corn Syrup | 12 to 14% |
| Albumin, spray dried egg white P-20 | 0.5 to 1% |
| Corn starch | 1 to 3% |
| Defatted cocoa (De Zaan type S) | 2 to 3% |
| Flavor (Dragoco 9/70H598) | 0.5 to 1% |
| Guar (Habib Procol G2) | 0.25 to 0.75% |
| Moisture | 1 to 3% |

The mixed, dry components were further prepared according to the invention.

### Example 12

### Low-Fat Dark Chocolate Coating of the Invention with Sorbitol

The components (in grams) are as follows:

| | |
|---|---|
| Sorbitol | 650 |
| Corn syrup (42 DE, 80% TSS) | 180 |
| Whole liquid milk | 150 |
| Cocoa | 100 |
| Corn starch | 20 |
| Flavor | 17 |
| Albumin | 8.3 |
| Guar gum | 5 |

The dry and wet ingredients are mixed as described previously to provide a low-fat dark chocolate coating according to the invention.

### Examples 13 and 14

The low fat preparations of example 4 (dark appearance) and example 5 (milk appearance) were taken (without drying).

These preparations were placed into a dipping tank.

Regular ice cream products (bars on sticks) were frozen to a surface temperature of −15 C. by dipping them in liquid nitrogen for 1 second. These bars were then inserted into the low fat preparations.

The bars remained submerged in the coating for 2 seconds and were then extracted.

The coated bars were then dipped in liquid nitrogen for 2 seconds (to prevent any undesirable subsequent flowing of the low fat coating during short-term transfers between unit operations).

The bars were then subjected to forced dry air circulation for 30 minutes in a blast freezer (equipped with remote condenser) and operated at −32 C. This completed the hardening procedure.

### Examples 15 and 16

The low fat preparations of example 4 (dark appearance) and example 5 (milk appearance) were taken (without drying).

Regular ice cream moulds were pre-cooled in a brine bath to an internal surface temperature of −40C. The low fat preparations were poured into these moulds until they were 95% full.

The preparations were allowed to stand in the moulds until a skin of frozen low fat preparation had formed lining the inside surface of the moulds. Skins of varying thickness can be obtained by varying this standing time.

A vacuum line was then used to substantially suck out the remaining fluid low fat preparation.

Regular ice cream was introduced into the moulds and, at an appropriate time judged by firmness of the ice cream, a stick was inserted.

The moulds were then inserted in a warm water batch at +27 C. for approximately 15 seconds. The products (bars) were released from the moulds by pulling up on the sticks when the surfaces of the bars (in contact with the interior surface of the moulds) had just commenced to thaw.

The bars were then subjected to forced dry air circulation for 30 minutes in a blast freezer (equipped with remote condenser) and operated at −32 C. This completed the hardening procedure.

The term “about,” as used herein, should generally be understood to refer to both numbers in a range of numerals. Moreover, all numerical ranges herein should be understood to include each whole integer within the range.

The term “dry,” as used herein, means that no water is added to the non-aqueous hydrocolloids used in the hydrocolloid component. Thus, although water may be present elsewhere in the coatings, it is not added to the microspheres. The hydrocolloids in the coating preferably have less than about 5 weight percent water, more preferably less than about 0.5 weight percent water content.

The term “substantially anhydrous,” as used herein, typically means that less than about 15 weight percent water, preferably less than about 3 weight percent, and more preferably less than about 2 weight percent, water is included in the final coating of the invention. This term includes completely anhydrous, which means no water except trace amounts present from the atmosphere, i.e., the components have no water added.

The term “reduced-fat,” as used herein, means that the coatings are (a) reduced in fat, calories, or both, compared to conventional coatings and particularly chocolate coatings or analogues thereof, and (b) contain no added fat.

Although preferred embodiments of the invention have been described in the foregoing description, it will be understood that the invention is not limited to the specific embodiments disclosed herein but is capable of numerous modifications by one of ordinary skill in the art. It will be understood that the materials used and the chemical details may be slightly different or modified from the descriptions herein without departing from the methods and compositions disclosed and taught by the present invention.

1. A reduced-fat flavored coating comprising:
a flavoring agent in an amount sufficient to provide a selected flavor;
a sugar matrix of sugar crystals and sugar glass in an amount effective to provide the coating with sufficient structural integrity to prevent flowability at temperatures less than about 40° C.; and
a plurality of microspheres comprising a dry hydrocolloid component that are dispersed through the flavoring agent and sugar matrix to provide a slippery mouthfeel that mimics fat and begins to disperse when in contact with saliva so as to mimic the melting of cocoa butter during consumption of chocolate,
the flavored coating is at least substantially anhydrous and has less than about 10 weight percent fat, and the fat that is present exists as dispersed microdroplets within the coating.

2. The flavored coating of claim 1, wherein the hydrocolloid component is selected from the group consisting of an isolated proteinaceous material, a galactomannan, a granular starch, and combinations thereof.

3. The flavored coating of claim 1, wherein the hydrocolloid component is selected from the group consisting of egg albumin, whey protein isolate, soy protein isolate, casein, sodium caseinate, guar gum, locust bean gum, fenugreek gum, tara gum, gum acacia, corn starch, potato starch, wheat starch, tapioca starch, and combinations thereof.

4. The flavored coating of claim 1, wherein the hydrocolloid component comprises guar gum, egg albumin, and at least one starch.

5. The flavored coating of claim 1, wherein the hydrocolloid component comprises at least one non-crosslinkable hydrocolloids.

6. The flavored coating of claim 1, wherein the hydrocolloid component will dissolve become dissolved at about 36° C. to 38° C. in saliva.

7. The flavored coating of claim 1, wherein the microspheres swell in contact with a consumer's mouth and release a portion of the hydrocolloid component to permit disintegration thereof.

8. The flavored coating of claim 1, wherein the coating is glossy and the dispersed hydrocolloid component washes away from the mouth in about 80 to 120 percent of the time that it takes an equivalent amount of chocolate to wash away from the mouth.

9. The flavored coating of claim 1, wherein the sugar matrix is selected from the group consisting of sucrose, glucose, fructose, sorbitol, mannitol, maltitol, xylitol, erythritol, lactitol, polydextrose, maltodextrin, and combinations thereof.

10. The flavored coating of claim 1, wherein the sugar matrix comprises corn syrup and powdered sucrose.

11. The flavored coating of claim 1, further comprising a milk component having a water content of less than 3 percent by weight.

12. The flavored coating of claim 1, wherein the flavoring agent comprises cocoa.

13. The flavored coating of claim 12, wherein a portion of the cocoa is alkalized cocoa.

14. The flavored coating of claim 1, wherein the water activity is about 0.45 to 0.55.

15. The flavored coating of claim 1, wherein the coating is anhydrous.

16. The flavored coating of claim 1, wherein the coating has a shelf-life of at least about 3 years without refrigeration.

17. The flavored coating of claim 1, wherein the coating will not leave a visibly detectable amount of coating on a human hand in an ambient environment.

18. The flavored coating of claim 1, wherein the coating is substantially free of a grit-increasing agent.

19. A method of enrobing a confectionery product which comprises the steps of:
placing a reduced-fat flavored coating comprising a flavoring agent in an amount sufficient to provide a selected flavor, a sugar matrix of sugar crystals and sugar glass in an amount effective to provide the coating with sufficient structural integrity to prevent flowability at temperatures less than about 40° C., and a plurality of microspheres comprising a dry hydrocolloid component that are dispersed through the flavoring agent and sugar matrix to provide a slippery mouthfeel that mimics fat and begins to disperse when in contact with saliva so as to mimic the melting of cocoa butter during consumption of chocolate, the flavored coating is at least substantially anhydrous and has less than about 10 weight percent fat, and the fat present exists as dispersed microdroplets within the coating over a portion of a confectionery products and
drying the flavored coating to at least a substantially anhydrous state.

20. A method of making a reduced-fat flavored coating which comprises:
combining a sufficient amount of flavoring agent to provide a selected flavor, a sugar matrix formed from a plurality of sugar crystals and sugar glass, and a plurality of microspheres comprising a dry hydrocolloid component to provide a slippery mouthfeel that mimics fat and begins to disperse when in contact with saliva so as to mimic the melting of cocoa butter when being consumed;
combining the flavoring agent, sugar matrix, and microspheres with milk to form a flowable reduced-fat flavored coating; and
drying to at least a substantially anhydrous form to provide the coating with a non-flowable texture, the reduced-fat flavored coating has less than about 10 weight percent fat which exists as dispersed micro-droplets.
